(19) United States
(12) Patent Application Publication
(10) Pub. No.: US 2019/0320635 A1
(43) Pub. Date: Oct. 24, 2019

(54) Slip Bobber Assembly

(71) Applicant: Ralph Stagat, New Hamburg (CA)

(72) Inventor: Ralph Stagat, New Hamburg (CA)

(21) Appl. No.: 15/957,104

(22) Filed: Apr. 19, 2018

(51) Int. Cl. A01K 93/00; A01K 91/03

(52) U.S. Cl. CPC A01K 93/00; A01K 91/03

(57) ABSTRACT

A slip bobber assembly for preventing bobber obstruction of rod guides includes a float, a ring and a clip. The ring is coupled to a first end of the float and defines a loop. The ring is configured to insert a line through the loop. The clip is coupled to a second end of the float and is configured to reversibly couple to the line. The clip is configured to fixedly position the float on the line so that a hook that is coupled to the line is positioned at a desired depth in a body of water. The clip is configured to decouple from the line upon a strike by a fish on the hook. The line is positioned to slide within the loop so that the float is prevented from obstructing guides on a fishing rod that is coupled to the line.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to bobber assemblies and more particularly pertains to a new bobber assembly for preventing bobber obstruction of rod guides.

### BRIEF SUMMARY OF THE INVENTION

An embodiment of the disclosure meets the needs presented above by generally comprising a float, a ring and a clip. The ring is coupled to a first end of the float and defines a loop. The ring is configured to allow insertion of a line through the loop. The clip is coupled to a second end of the float and is configured to reversibly couple to the line. The clip is configured to fixedly position the float on the line so that a hook that is coupled to the line is positioned at a desired depth in a body of water. The clip is configured to decouple from the line upon a strike by a fish on the hook. The line is positioned to slide within the loop so that the float is prevented from obstructing guides on a fishing rod that is coupled to the line.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a slip bobber assembly according to an embodiment of the disclosure.

FIG. 2 is a side view of an embodiment of the disclosure.

FIG. 3 is a side view of an embodiment of the disclosure.

FIG. 4 is a cross-sectional view of an embodiment of the disclosure.

FIG. 5 is an in-use view of an embodiment of the disclosure.

### DETAILED DESCRIPTION OF THE INVENTION

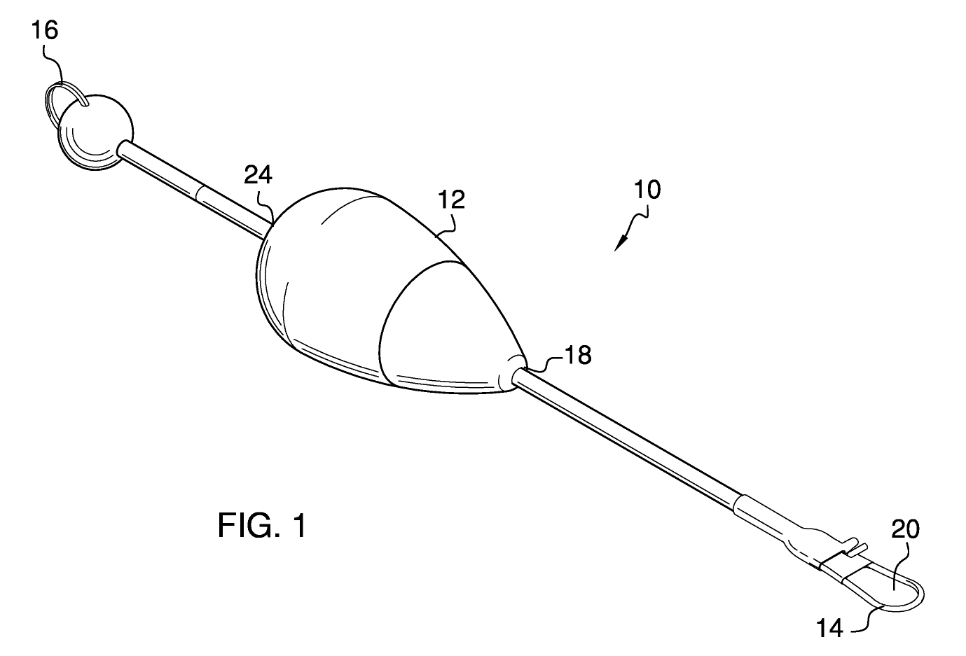

With reference now to the drawings, and in particular to FIGS. 1 through 5 thereof, a new bobber assembly embodying the principles and concepts of an embodiment of the disclosure and generally designated by the reference numeral 10 will be described.

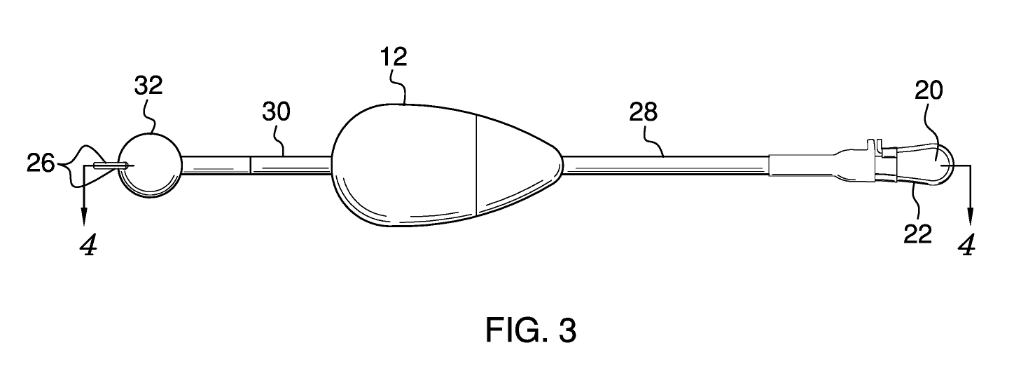

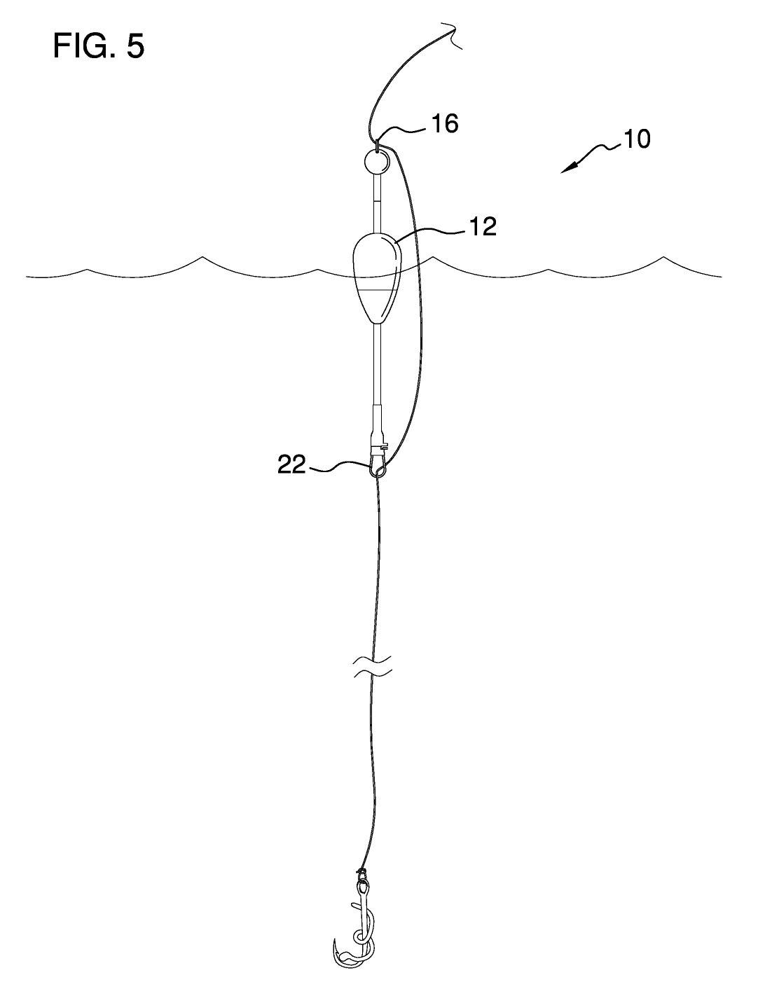

As best illustrated in FIGS. 1 through 5, the slip bobber assembly 10 generally comprises a float 12, a ring 14, and a clip 16. The float 12 is substantially egg shaped, or the like. The ring 14 is coupled to a first end 18 of the float 12 and defines a loop 20. The ring 14 is configured to insert a line through the loop 20, as shown in FIG. 5. The ring 14 comprises a safety snap 22, or the like, as shown in FIG. 3. The safety snap 22 is configured to be opened to insert the line into the loop 20 and to be closed to retain the line within the loop 20, as shown in FIG. 5.

The clip 16 is coupled to a second end 24 of the float 12. The clip 16 is configured to reversibly couple to the line to fixedly position the float 12 on the line so that a hook that is coupled to the line is positioned at a desired depth in a body of water. The clip 16 is configured to decouple from the line upon a strike by a fish on the hook so that the line is positioned to slide within the loop 20. The float 12 is prevented from obstructing guides on a fishing rod that is coupled to the line. The clip 16 comprises a splitring coupler 26, or the like, as shown in FIG. 3.

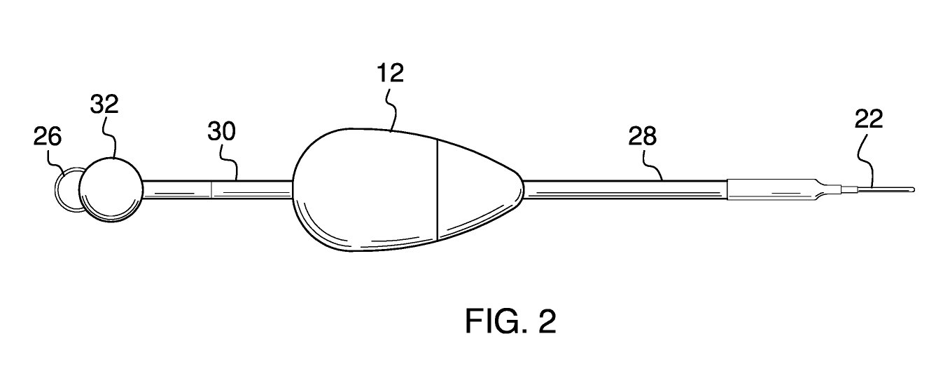

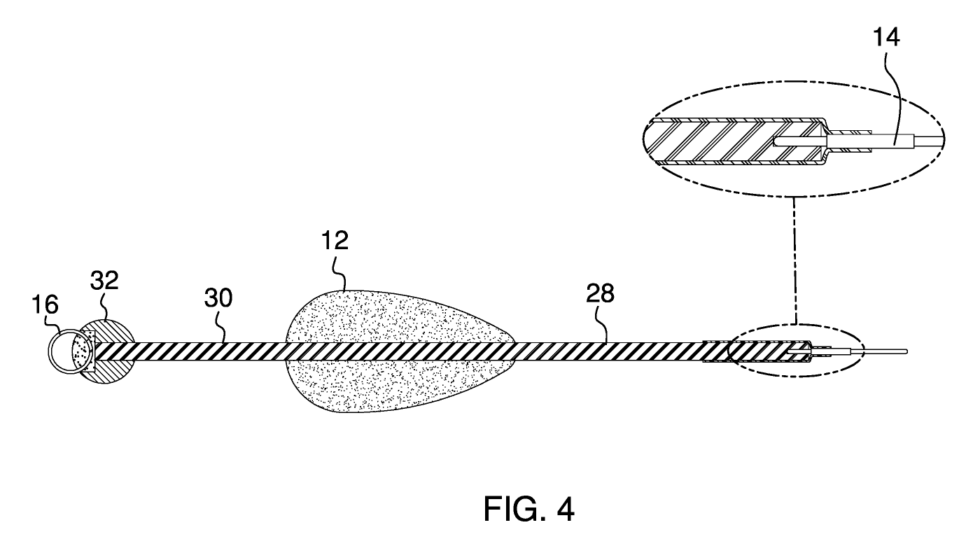

A first rod 28 is coupled to and is positioned between the float 12 and the ring 14, as shown in FIG. 2. The first rod 28 is circularly shaped when viewed longitudinally. A second rod 30 is coupled to and is positioned between the float 12 and the clip 16, as shown in FIG. 2. The second rod 30 is circularly shaped when viewed longitudinally. The second rod 30 and the first rod 28 extend into the float 12, as shown in FIG. 4. The second rod 30 is coupled to the first rod 28.

A shell 32, which is solid, is coupled to and is positioned between the second rod 30 and the splitring coupler 26. The splitring coupler 26 is partially embedded in the shell 32, as shown in FIG. 4. The shell 32 is substantially spherically shaped.

In use, the safety snap 22 is configured to be opened to insert the line into the loop 20 and to be closed to retain the line within the loop 20. The splitring coupler 26 is configured to reversibly couple to the line. The hook that is coupled to the line is positioned at the desired depth in the body of water. The splitring coupler 26 is configured to decouple from the line upon the strike by the fish on the hook. The line is positioned to slide within the loop 20 so that the float 12 is prevented from obstructing the guides on the fishing rod.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A slip bobber assembly comprising:
a float;
a ring coupled to a first end of said float defining a loop wherein said ring is configured for inserting a line through said loop; and
a clip coupled to a second end of said float wherein said clip is configured for reversibly coupling to the line such that said clip is configured for fixedly positioning said float on said line such that a hook coupled to the line is positioned at a desired depth in a body of water, wherein said clip is configured for decoupling from the line upon a strike by a fish on the hook such that the line is positioned for sliding within said loop such that said float is prevented from obstructing guides on a fishing rod coupled to the line.

2. The assembly of claim 1, further including said float being substantially egg shaped.

3. The assembly of claim 1, further including said ring comprising a safety snap such that said safety snap is configured for opening for inserting the line into said loop and for closing for retaining the line within said loop.

4. The assembly of claim 1, further including a first rod coupled to and positioned between said float and said ring.

5. The assembly of claim 4, further including said first rod being circularly shaped when viewed longitudinally.

6. The assembly of claim 4, further including a second rod coupled to and positioned between said float and said clip.

7. The assembly of claim 6, further including said second rod and said first rod extending into said float, said second rod being coupled to said first rod.

8. The assembly of claim 6, further including said second rod being circularly shaped when viewed longitudinally.

9. The assembly of claim 6, further comprising:
said clip comprising a splitring coupler; and
a shell coupled to and positioned between said second rod and said splitring coupler such that said splitring coupler is partially embedded in said shell, said shell being solid, wherein said splitring coupler is configured for inserting the line for frictionally coupling said splitring coupler to the line.

10. The assembly of claim 9, further including said shell being substantially spherically shaped.

11. A slip bobber assembly comprising:
a float, said float being substantially egg shaped;
a ring coupled to a first end of said float defining a loop wherein said ring is configured for inserting a line through said loop, said ring comprising a safety snap such that said safety snap is configured for opening for inserting the line into said loop and for closing for retaining the line within said loop;
a clip coupled to a second end of said float wherein said clip is configured for reversibly coupling to the line such that said clip is configured for fixedly positioning said float on said line such that a hook coupled to the line is positioned at a desired depth in a body of water, and wherein said clip is configured for decoupling from the line upon a strike by a fish on the hook such that the line is positioned for sliding within said loop such that said float is prevented from obstructing guides on a fishing rod coupled to the line, said clip comprising a splitring coupler;
a first rod coupled to and positioned between said float and said ring, said first rod being circularly shaped when viewed longitudinally;
a second rod coupled to and positioned between said float and said clip, said second rod being circularly shaped when viewed longitudinally, said second rod and said first rod extending into said float, said second rod being coupled to said first rod; and
a shell coupled to and positioned between said second rod and said splitring coupler such that said splitring coupler is partially embedded in said shell, said shell being solid wherein said splitring coupler is configured for inserting the line for frictionally coupling said splitring coupler to the line, said shell being substantially spherically shaped.
